(19) United States
(12) Patent Application Publication
(10) Pub. No.: US 2012/0094507 A1
(43) Pub. Date: Apr. 19, 2012

(54) CONNECTOR

(76) Inventors: Li-Chien WU, Taipei (TW); Pai-Ching Huang, Taipei (TW)

(21) Appl. No.: 13/241,330

(22) Filed: Sep. 23, 2011

(30) Foreign Application Priority Data
Oct. 13, 2010 (TW) 099134864

(51) Int. Cl. H01R 12/71

(52) U.S. Cl. 439/65

(57) ABSTRACT

A connector is disposed at a circuit board and utilized for connecting to an external connecting port which is detachably connected to the connector of the circuit board via a connecting terminal, so as to provide an expansion connecting channel between the connecting port and the circuit board. The connector includes the plurality of power pins and the plurality of signal pins, and the length of the power pins is longer than that of the signal pins along an assembling direction of the connecting terminal to the connector. Thus, when the connecting terminal is removed from the connector, the connecting terminal is detached from the connecting pins first to stop the data transmission to avoid the data loss or damage due to the power off, thus to achieve the “hot-plug” function, and also to avoid the damage of the host or the external device.

### CROSS REFERENCE TO RELATED APPLICATIONS

This Non-provisional application claims priority under 35 U.S.C. §119(a) on Patent Application No(s). 099134864 filed in Taiwan, Republic of China on Oct. 13, 2010, the entire contents of which are hereby incorporated by reference.

### BACKGROUND OF THE INVENTION

1. Field of Invention

The invention relates to a connector.

2. Related Art

To expand the functions of a motherboard of personal computers, service hosts or other systems, users may insert an expansion card to the extended slot of the motherboard, or dispose a plurality of extended connectors at the motherboard. The connectors includes a plurality of metal pins (which usually include power pins and signal pins) extended from the motherboard, and they are connected to an input/output (I/O) port at the rear panel of the host or various connecting port at a casing via a flexible signal cable.

Some connecting ports have the function that support “hot plug” between the connecting port and an external device, such as universal serial bus (USB) 2.0, USB 3.0, IEEE 1394 and e-SATA connecting ports. “Hot plug” function provides that the external device can be connected or disconnected via the connecting port without interrupting the operation of the host system. However, as the conventional connectors only transmits the signal from the motherboard to a bus then given out via an external connecting port with “hot plug” function supported, the host or the external device still may be damaged or lost data, when the connecting port is plug-in or plug-out from the connector of the motherboard via a signal cable.

### SUMMARY OF THE INVENTION

A connector disposed at a circuit board is disclosed. The connector is utilized for connecting a connecting terminal and includes a plurality of power pins and a plurality of signal pins. The power pins have a first length, and the signal pins have a second length. When the connecting terminal is connected to the connector, the connecting terminal is first electrically connected to the plurality of the power pins, and then electrically connected to the plurality of the signal pins.

Also, a circuit board with the connector described above which disposed thereon, and an electronic device having the circuit board are disclosed herein.

Compare to the signal pins of the connectors, longer power pins, longer ground pins and shorter signal pins would achieve the hot plug function, which ensures that the important data will not be lost or damaged while the connector coupled to the connecting terminals of the connector port, thus a safe connection is provided.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a side view of a connector in a first embodiment;

FIG. 2 is a schematic diagram showing that the connector in the first embodiment is disposed at a circuit board and connected to a connecting terminal along an assembly direction;

FIG. 3 is a schematic diagram showing a side of a connector in a second embodiment; and

FIG. 4 is a schematic diagram showing an electronic device in an embodiment.

### DETAILED DESCRIPTION OF THE INVENTION

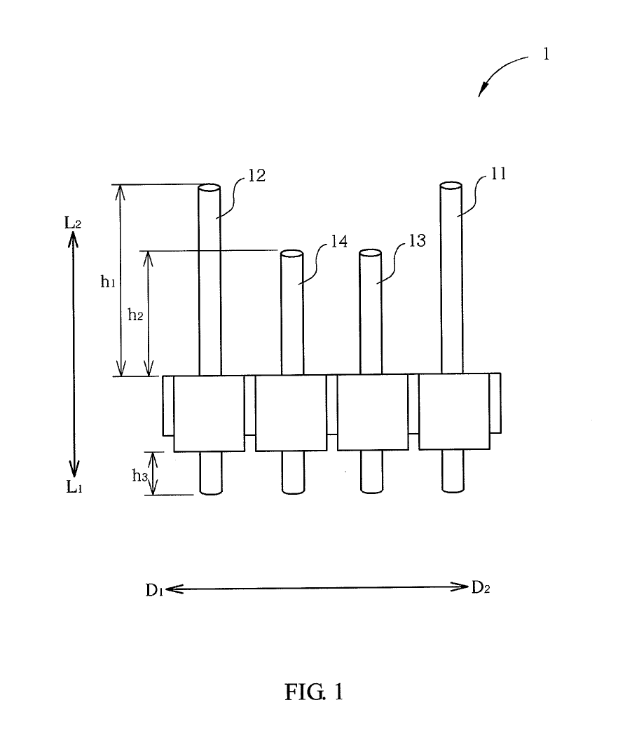

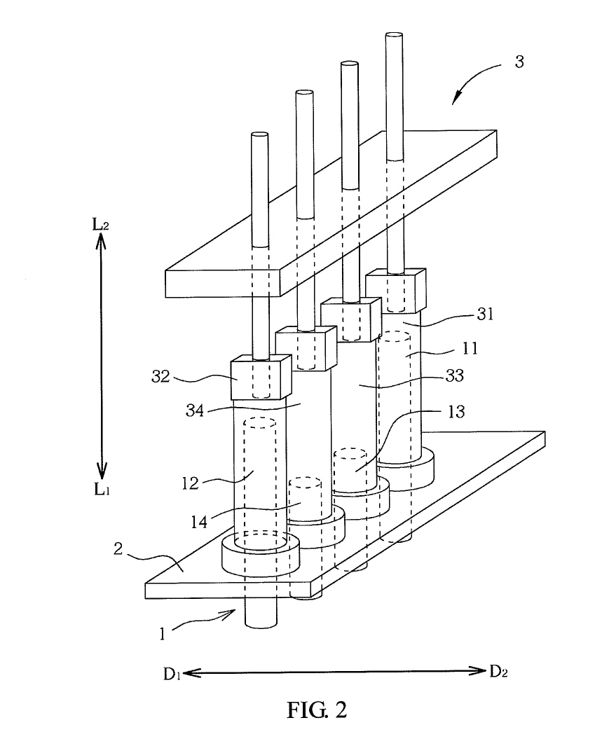

FIG. 1 is a schematic diagram showing a side view of a connector 1 in a first embodiment. FIG. 2 is a schematic diagram showing that the connector 1 in the first embodiment is disposed at a circuit board 2. In the first embodiment, the connector 1 is disposed at the circuit board 2 via dual in-line package (DIP). The circuit board 2 may be a motherboard of a computer system, a circuit board of an expansion card, or a printed circuit board with other applications. The connector 1 disposed at the circuit board 2 for selectively connected to other electronic elements or devices such as an expansion card, a connecting port or an input/output (I/O) port. The connector 1 includes a plurality of metal pins 11 to 14. The thickness of a common printed circuit board is approximately at 1.6 mm. Consequently, when the connector is disposed at the circuit board 2 via the DIP, the length h3 of each pin 11 to 14 passing through the circuit board 2 is longer than the thickness of the circuit board 2, which preferably matches the thickness of the circuit board 2, such as 2.0 mm, thus to avoid the signal loss and prevent the reflected signal interference when an electronic signal is transmitted to the circuit board 2 via the connector 1. As a result, the connector 1 described above can be adapted to both high-speed and low-speed electrical signal transmission.

In FIG. 2, the connector 1 is disposed on the circuit board 2 and connected to a connecting terminal 3 of a connecting port. The connecting port may comply with connecting standard such as any current versions of universal serial bus (USB), ex. 2.0, or 3.0, IEEE 1394, e-SATA standard or any signal connecting port of an I/O device provided by the circuit board 2. When the connecting terminal 3 is connected to the connector 1, a connecting point outside the circuit board 2 (such as at the casing of the host) for connecting to other devices is provided via a signal bus (not shown) that connected to the connecting terminal 3.

In FIG. 1 and FIG. 2, the connecting terminal 3 is inserted to the connector 1 along the direction L₁, and it can be detached from the connector 1 along the direction L₂. To ensure the signal and the device are safe while plug-in or plug-out from the connector 1, the metal pins 11 to 14 comprises the power pins and the signal pins of the connector 1 are with different pin length in the first embodiment. For example, the metal pins of the connector 1 are the power pin +5V 11, the signal pin Tx 13, the signal pin Rx 14 and the ground pin GND 12 in sequence. The pins 11 and 12 are the power pins, and the pins 13, 14 are the signal pins. In order to support “hot plug” of the connector 1, the length of the pins 11, 12 is h₁, the length of the pins 13, 14 is h₂ along the inserting and detaching direction L₁L₂, and h₁ is longer than h₂.

Thus, when the connecting terminal 3 (in the embodiment of FIG. 2, the connecting terminal 3 includes a plurality of sleeve contacts 31 to 34 corresponding to each pins 11 to 14) is connected to the connector 1 along the direction L₁, the sleeve contacts 31,32 of the connecting terminal 3 are electrically connected to the connecting pins 11, 12 (the power pin and the ground pin) first to establish a power channel between the circuit board 2 and the connecting port for supplying power to the external device. Then, the sleeve contacts 33, 34 are electrically connected to the connecting pins 13, 14 (the signal pins) to establish a signal channel between the circuit board 2 and the connecting port to exchange data.

When the connecting terminal 3 is detached along the direction L₂, the sleeve contacts 33, 34 of the connecting terminal 3 are first detached from the connecting pins 13, 14 to stop the data transmission to avoid the data missing or damage due to the power off Then, the sleeve contacts 31, 32 of the connecting terminal 3 are detached from the connecting pins 11, 12 to cut off the power and the ground connection of the external device. As for the connecting port connected to a high-speed signal, it is still connected with the ground at the moment of disconnecting the power to avoid the ground bounce.

According to the embodiment, when the connecting port or an I/O port which supports “hot plug” is connected to an external device, the connector 1 in the first embodiment ensures a hot plug protection is performed between the connector 1 of the circuit board 2 and the connecting terminal 3.

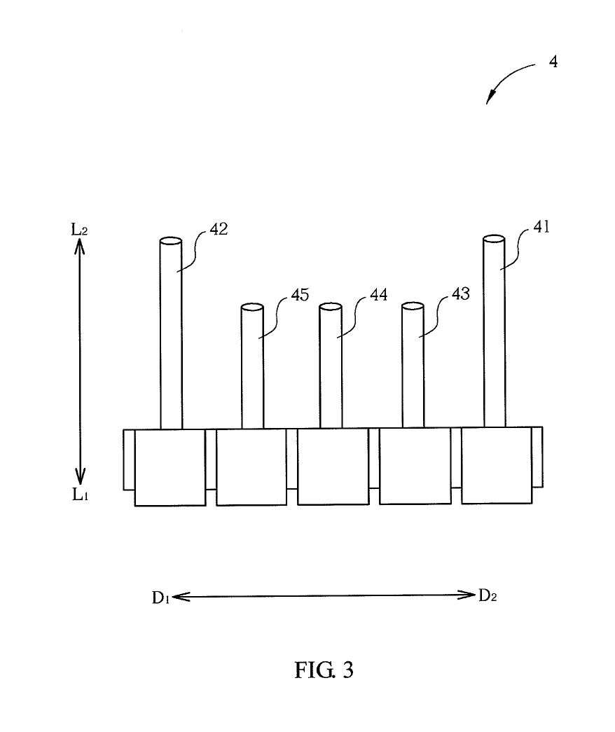

FIG. 3 is a schematic diagram showing a side view of a connector 4 in a second embodiment of the invention. The connector 4 can be disposed at the circuit board 2 via DIP as described in the first embodiment or via surface mounted technology (SMT). In the second embodiment, the length of the power pins 41, 42 of the connector 4 is longer than that of the signal pins 43, 44, 45 along the direction L₁ to L₂, and the configuration is similar to that of the first embodiment, which is omitted herein.

In the embodiments described herein, all pins of the connector 1, 4 are arranged along the direction D₁D₂, and the power pins 11, 12 (or the power pins 41, 42) are disposed outside of the signal pins 13, 14 (or the signal pins 43 to 45). The order of the pins is varies and depends to the specification of the connecting port utilized. According to the connecting port, a part of the pins can be selectively connected the circuit board 2 and the connecting port, while other pins are not connected to traces at the circuit board 2. When the connector 1, 4 is used, the signal corresponding to each pin of the connector 1, 4 is configured according to circuit traces of the circuit board 2 and the standardized connecting port. Furthermore, except for the displacement in the embodiment shown in the figure, the pins also may be arranged in other arrangements such as side by side, or the signal pins 13, 14 (or the signal pins 43 to 45) between the power pin 11, 12 (or the power pins 41, 42) are arranged in an order different from that of the signal pins of the connecting port, and thus the connectors 1, 4 can be applied more widely and flexibly.

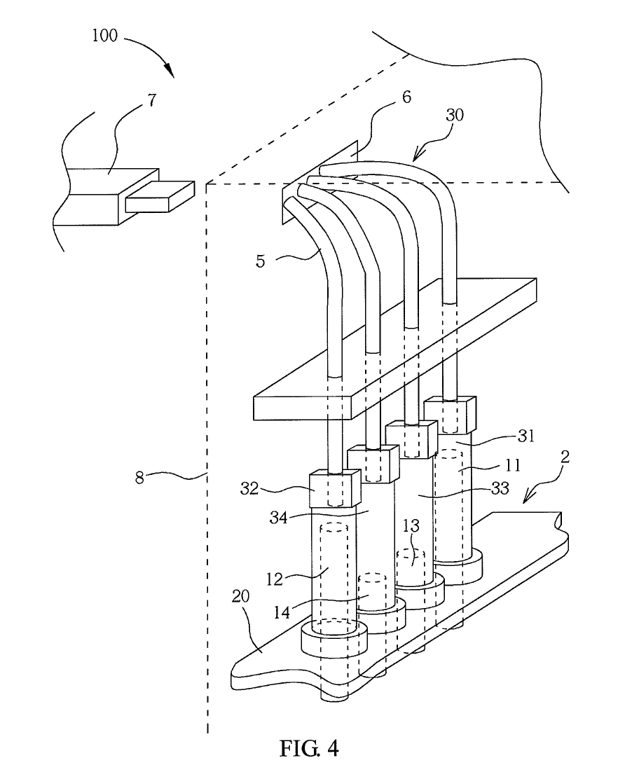

FIG. 4 is a schematic diagram showing part of an electronic device 100 applying the connector 1. The electronic device 100 may be any electronic device with expanded functions such as a desktop computer, a notebook computer, an external electrical peripheral device, a printer or a network device. A connector 1 is disposed at the plate body 20 of the circuit board 2 of the electronic device 100. The electronic device 100 further includes a connecting port 30 such as USB 2.0, USB 3.0, IEEE 1394 or e-SATA ports for connecting the electronic device 100 to other expansion devices. Please also refer to FIG. 2. The connecting port 30 includes an external terminal 6, a connecting terminal 3 and a cable 5. The cable 5 is connected to the external terminal 6 and the connecting terminal 3. The connecting terminal 3 is connected with the connector 1 to connect to the circuit board 2 as stated above (also as showed in FIG. 2). The external terminal 6 is disposed at the casing 8 of the electronic device 100 for connecting an external device 7 to the electronic device 100.

The connector disclosed herein is connected to a circuit board and an external connecting port. The connecting port is detachably connected to the connector to provide an expanded connecting channel between the connecting port and the circuit board. The connector includes a plurality of power pins and a plurality of signal pins. The length of the power pins is longer than that of the signal pins along the connection direction of the connecting terminal and the connector. Thus, when the connecting terminal is removed from the connector, the connecting terminal 3 is detached from the connecting pins first to stop the data transmission to avoid the data lost or damaged due to the power off, the host or the external device.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A connector disposed at a circuit board for connecting to a connecting terminal of a connecting port, the connector comprising:
a plurality of power pins in a first length; and
a plurality of signal pins in a second length;
wherein when the connecting terminal of the connecting port is connected to the connector, the connecting terminal is first electrically connected to the plurality of the power pins, and then electrically connected to the plurality of the signal pins.

2. The connector according to claim 1, wherein the signal pins are arranged in an order corresponding to a specification of the connecting port.

3. The connector according to claim 1, wherein the first length of the power pins is longer than the second length of the signal pins.

4. The connector according to claim 1, wherein the connector is disposed at the circuit board via dual in-line package (DIP) or surface mounted technology (SMT).

5. The connector according to claim 1, wherein the connector is connected to the connecting port conforming to universal serial bus (USB), IEEE 1394 or e-SATA specification.

6. The connector according to claim 1, wherein the plurality of the power pins are disposed outside of the signal pins.

7. A circuit board disposed in an electronic device, comprising:
a plate body;
a connector including a plurality of power pins and a plurality of signal pins and disposed at the plate body, wherein the plurality of the power pins have a first length, the plurality of the signal pins have a second length; and
a connecting port including a connecting terminal and a cable, wherein the connecting port is connected with the connector via the connecting terminal and connects to the plate body;
when the connecting terminal is connected with the connector, the connecting terminal is first electrically connected to the plurality of the power pins, and then electrically connected to the plurality of the signal pins.

8. The circuit board according to claim 7, wherein the signal pins of the connector are arranged in an order complied with a specification of the connecting port.

9. The circuit board according to claim 7, wherein the first length of the power pins is longer than the second length of the signal pins.

10. The circuit board according to claim 7, wherein the connector is disposed at the plate body via DIP or SMT.

11. The circuit board according to claim 7, wherein the standardized connecting port conforms to USB, IEEE 1394 or e-SATA specification.

12. The circuit board according to claim 7, wherein the plurality of the power pins of the connector are disposed outside of the signal pins.

13. An electronic device, comprising:
a casing;
a circuit board, having a connector disposed at the circuit board, the connector includes a plurality of power pins and a plurality of signal pins, the power pins have a first length, and the signal pins have a second length; and
a connecting port including an external terminal, a connecting terminal and a cable, wherein the external terminal is disposed at the casing to connect to an external device, the cable is connected between the external terminal and the connecting terminal, and the connecting port is connected with the connector via the connecting terminal and connect to the circuit board;
when the circuit board and the connecting port are disposed in the casing, and the connecting terminal is connected with the connector, the connecting terminal is first electrically connected to the plurality of the power pins, then electrically connected to the plurality of the signal pins, and the external device is connected to the circuit board via the connecting port and the connector.

14. The electronic device according to claim 13, wherein the plurality of the signal pins of the connector are arranged in an order to comply a specification of the connecting port.

15. The electronic device according to claim 13, wherein the first length of the power pins is larger than the second length of the signal pins.

16. The electronic device according to claim 13, wherein the connector is disposed at a plate body of the circuit board via DIP or SMT.

17. The electronic device according to claim 13, wherein the connecting port conforms to USB, IEEE 1394 or e-SATA specification.

18. The electronic device according to claim 13, wherein the plurality of the power pins of the connector are disposed outside of the signal pins.
